(19) United States
(12) Patent Application Publication
(10) Pub. No.: US 2009/0144549 A1
(43) Pub. Date: Jun. 4, 2009

(54) COPYRIGHT PROTECTION PROCESSING APPARATUS AND COPYRIGHT PROTECTION PROCESSING METHOD

(76) Inventors: Kazuhiro MATSUYAMA, Machida-shi (JP); Hiroshi Ohyama, Tokorozawa-shi (JP); Kunio Honsawa, Ome-shi (JP); Chikara Ushimaru, Hamura-shi (JP); Atsushi Nakajima, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/271,004

(22) Filed: Nov. 14, 2008

(30) Foreign Application Priority Data
Nov. 30, 2007 (JP) 2007-311162

(51) Int. Cl. H04L 9/00

(52) U.S. Cl. 713/169

(57) ABSTRACT

According to one embodiment, a copyright protection processing apparatus is provided in a source device containing content items that are objects of copyright protection. The apparatus includes a network interface which is connected to a sink device which utilizes the content items, and a protection process section which executes mutual authentication for exchanging keys requested by the sink device in a state where a network connection is established with the sink device via the network interface and performs a protection process of encrypting the content items by the secret key shared as a result of successful mutual authentication and transmitting the encrypted content items to the sink device. A content list process section adds an item of error information to the content list to be transmitted to the sink device, upon failure in the mutual authentication.

### CROSS-REFERENCE TO RELATED APPLICATIONS

This application is based upon and claims the benefit of priority from Japanese Patent Application No. 2007-311162, filed Nov. 30, 2007, the entire contents of which are incorporated herein by reference.

### BACKGROUND

1. Field

One embodiment of the present invention relates to a copyright protection processing apparatus and a copyright protection processing method for transmitting content items that are objects of copyright protection typically by means of the DTCP-IP (Digital Transmission Content Protection over Internet Protocol).

2. Description of the Related Art

Digital home electric appliances having communication features, which are also referred to as digital information equipment, have become and are increasingly popular in response to the propagation of computer networks including broadband networks and wireless LANs and the development of digital technologies. Additionally, digital terrestrial broadcasting has started in Japan and television sets, set top boxes, DVD recorders and so on that are compatible with digital broadcasting are expected to become very popular. A number of digital home electric appliances connected to a network at home may be of great interest to the users because they can enjoy content items via a network.

The expression of content items as used herein refers to moving data and audio data conforming to MPEG-2 and MPEG-4 as well as to document data such as text data and image data. While such content items of digital data provide an advantage that they can be copied with ease and without degradation, attention needs to be paid to the copyright of content items. When content items that are objects of copyright protection are copied from a specific digital information equipment to another, they are desirably not copied by any other digital information equipment on the communication path.

The technique of DTCP-IP is known as means for preventing content items from being copied by a third party digital information equipment. With the DTCP-IP technique, the source device having content items that are objects of copyright protection and the sink device that is going to utilize the content items authenticate each other and exchange keys when the mutual authentication (AKE) is completed successfully. Then, the source device encrypts the content items by means of the secret key that is shared by the two parties as a result of the key exchange and transmits the encrypted content items to the sink device. Upon receiving the encrypted content items, the sink device decrypts the content items by means of the secret key and reproduces any of them. With this arrangement, content items that are objects of copyright protection can be shared by, for example, home LAN.

Normally, when the source device and the sink device fail in mutual authentication, no key exchange takes place so that the content items held in the source device cannot be reproduced. Conventionally, a message telling success or failure of mutual authentication is transmitted from the source device to the sink device (see, refer to Jpn. Pat. Appln. Publication No. 2007-235246).

However, if the mutual authentication fails, the cause of the failure cannot be identified simply from the message telling the failure. Possible causes of the failure may include an incorrect connection of the equipment and a wrong setting at either or both of the equipment.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic exemplary illustration of a home network system that can be used for first embodiment of the present invention, showing the configuration thereof;

FIG. 2 is a schematic exemplary illustration of the copyright protection processing circuit arranged in the source device of FIG. 1, showing the configuration thereof;

FIG. 3 is a schematic exemplary illustration of the sequence of operation that is followed between the source device and the sink device of FIG. 1;

FIG. 4 is a schematic exemplary illustration of the key exchange of the source device and that of the sink device of FIG. 1 that are performed when they fail in mutual authentication (AKE);

FIG. 5 is a schematic exemplary list of content items that can be displayed when the source device and the sink device of FIG. 1 succeed in mutual authentication (AKE);

FIG. 6 is a schematic exemplary list of content items that can be displayed when the source device and the sink device of FIG. 1 fail in mutual authentication (AKE);

FIG. 7 is a schematic exemplary list of content items different from that of FIG. 6 that can be displayed when the source device and the sink device of FIG. 1 fail in mutual authentication (AKE);

FIG. 8 is a schematic exemplary illustration of content list information applicable to the exemplary display of FIG. 5 when the source device and the sink device succeed in mutual authentication (AKE);

FIG. 9 is a schematic exemplary illustration of error information to be added to content list information in order to obtain the exemplary display of FIG. 6 when the source device and the sink device fail in mutual authentication (AKE);

FIG. 10 is a schematic exemplary illustration of error information to be added to content list information in order to obtain the exemplary display of FIG. 7 when the source device and the sink device fail in mutual authentication (AKE);

FIG. 11 is a schematic exemplary illustration of the operation to be performed by a home network system that can be used for the second embodiment of the present invention; and

FIG. 12 is a schematic exemplary illustration of a modified format for displaying a content list that can be obtained as a result of mutual authentication (AKE) of FIG. 11.

### DETAILED DESCRIPTION

Various embodiments according to the invention will be described hereinafter with reference to the accompanying drawing.

According to one embodiment of the present invention, there is provided a copyright protection processing apparatus serving as source device capable of transmitting content items that are objects of copyright protection, the apparatus comprising: a network interface which is connected to a sink device for receiving the content items; a content list process section which transmits a list of content items transmittable to the sink device via the network interface in response to a request from the sink device; and a protection process section which executes mutual authentication for exchanging keys via the network interface and performs a protection process of encrypting the content items by the secret key shared as a result of successful mutual authentication and transmitting the encrypted content items to the sink device; the content list process section being configured to add an item of error information to the content list to be transmitted to the sink device, upon failure in the mutual authentication executed by the protection process section.

According to one embodiment of the present invention, there is provided a copyright protection method comprising: transmitting a content list transmittable to a sink device in response to a request from the sink device; executing mutual authentication for a key exchange requested by the sink device in a status where a network connection is established with the sink device which utilizes content items that are objects of protection; performing a protection process of encrypting the content items by the secret key shared as a result of successful mutual authentication and transmitting the encrypted content items to the sink device; and adding an item of error information to the content list to be transmitted to the sink device upon failure in the mutual authentication.

With the copyright protection processing apparatus and the copyright protection processing method as defined above, the user can identify the cause of the failure with ease when mutual authentication fails.

Now, a home network system that can be used for first embodiment of the present invention will be described below.

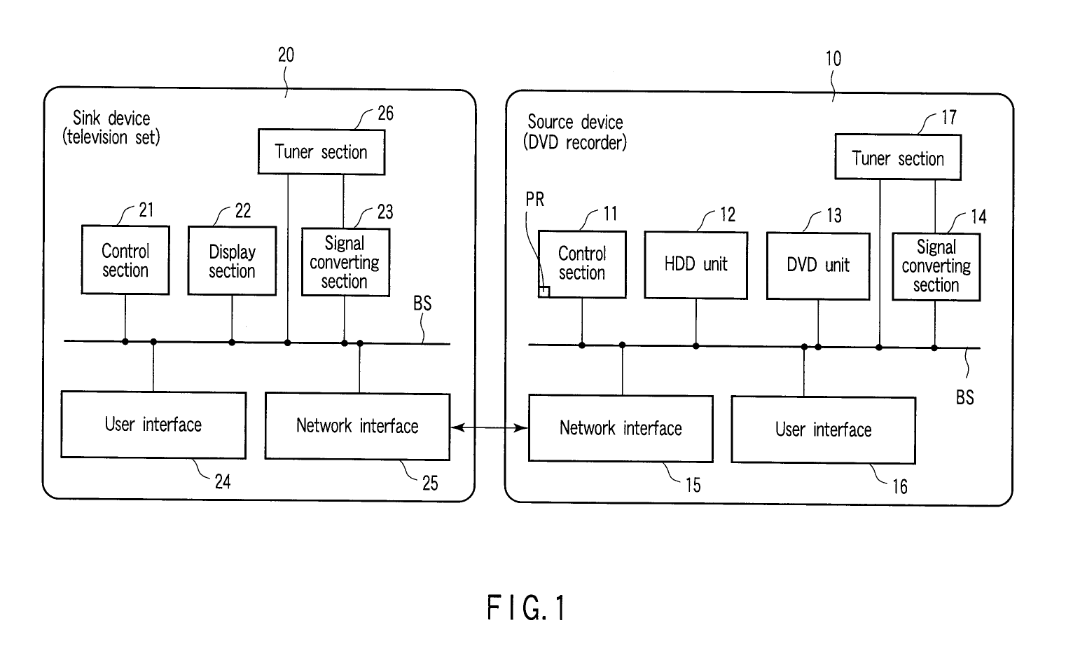

FIG. 1 is a schematic exemplary illustration of the home network system. The network system includes two digital information equipments that are connected to each other. One of the digital information equipment is a DVD recorder that operates as source device 10 and holds content items as objects of copyright protection, whereas the other is a television set that operates as sink device 20 and utilizes the content items that are held in the source device 10 as objects of copyright protection.

As shown in FIG. 1, the source device 10 includes a control section 11, a hard disk drive (HDD) unit 12, a DVD unit 13, a signal converting section 14, a network interface 15, a user interface 16 and a tuner section 17, which are connected to each other by a bus line BS. The control section 11 controls the components 12 through 17 in a manner required to properly operate the entire DVD recorder. It includes a CPU adapted to execute various processes including those necessary for the source device 10 to operate as copyright protection processing circuit PR for authenticating the device at the other end of the network connection for the purpose of transmitting content items to be received by the device at the other end, a ROM holding the control program of the CPU and initial data, a RAM for temporarily storing input/output data of the CPU and a buffer memory for temporarily storing content items. The tuner section 17 demodulates the content items received by way of digital terrestrial broadcasting that require copyright protection. The signal converting section 14 executes signal converting processes such as compression and expansion on the content items obtained from the tuner section 17 or the network interface 15. The HDD unit 12 stores the content items obtained from the signal converting section 13 in the hard disk thereof. The DVD unit 13 selectively converts the signals of the content items stored in the hard disk of the HDD unit 12 and records them on a DVD in the applicable disk recording format. The user interface 16 is operated by the user to input a command corresponding to the user's operation to the control section 11 and also notify the user of the message output from the control section 11. The network interface 15 is provided to establish a connection between the sink device 20 and the network for communication.

As shown in FIG. 1, the sink device 20 includes a control section 21, a display section 22, a signal converting section 23, a user interface 24, a network interface 25 and a tuner section 26, which are connected to each other by a bus line BS. The control section 21 controls the components 22 through 26 in a manner required to properly operate the entire television set. It includes a CPU adapted to execute various processes including those that make it equivalent to a copyright protection processing circuit PR, a ROM holding the control program of the CPU and initial data, a RAM for temporarily storing input/output data of the CPU and a buffer memory for temporarily storing content items. The tuner section 26 demodulates the content items received by way of digital terrestrial broadcasting that require copyright protection. The signal converting section 23 executes signal converting processes such as compression and expansion on the content items obtained from the tuner section 26 or the network interface 25. The display section 22 displays the content items obtained from the signal converting section 23. The user interface 25 is operated by the user to input a command corresponding to the user's operation to the control section 21 and also notify the user of the message output from the control section 21. The network interface 25 is provided to establish a connection between the source device 20 and the network for communication. Physical layer processes, data link layer processes and network layer and transport layer processes are executed at the network interface 25. The Internet protocol of DTCP-IP is adopted at the network layer.

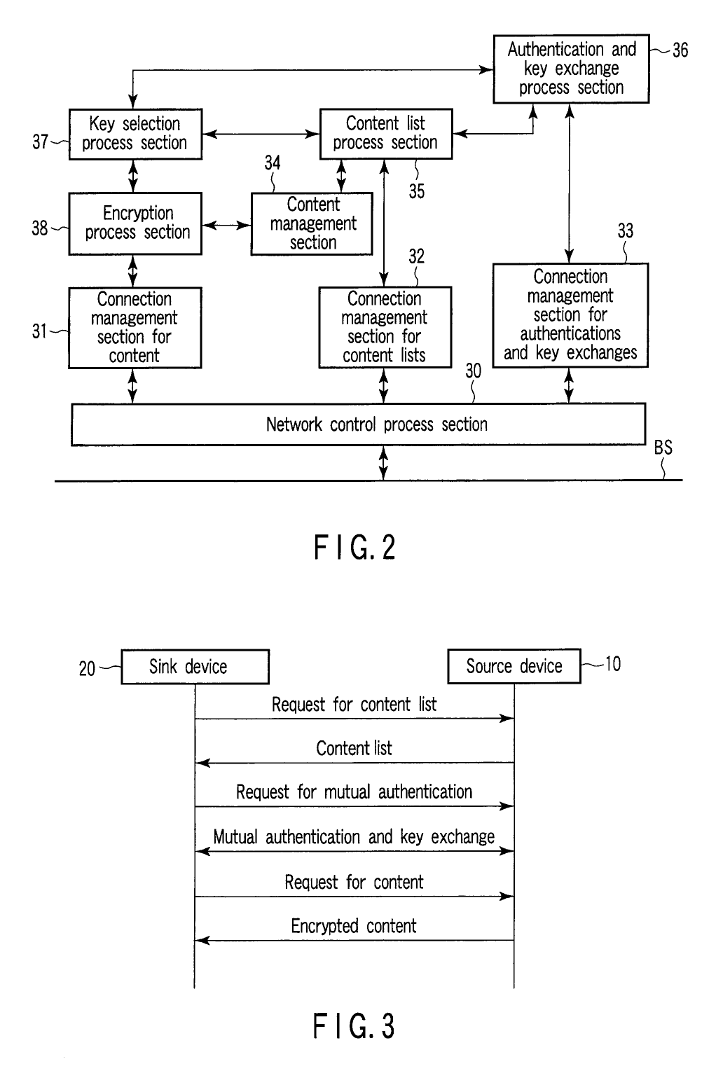

FIG. 2 is a schematic exemplary illustration of the copyright protection processing circuit PR in FIG. 1, showing the configuration thereof. The copyright protection process circuit PR includes a network control process section 30, a connection management section for content items 31, a connection management section for content lists 32, a connection management section for authentications and key exchanges 33, content management section 34, a content list process section 35, an authentication and key exchange process section 36, a key selection process section 37 and an encryption process section 38. The network control process section 30 controls the network interface 25 for inputs/outputs of information to be transmitted and received. The connection management section for content items 31 manages connections for transmitting content items to and receiving content items from the device at the other end of the network connection. The connection management section 32 for content lists manages connections for transmitting content lists to and receiving content lists from the device at the other end of the network connection. For instance, a protocol for AV equipment such as UPnP (Universal Plug and Play) AV will be adopted. The connection management section for authentications and key exchanges 33 manages connections for authentications and key exchanges.

The content management section 34 manages the stored content items and also inputs content items to and outputs content items from the encryption process section 38. The content list process section 35 outputs the list of the content items managed by the content management section 35 to the connection management section 32 for content lists and selects content items from the content list input from the connection management section for content lists 32. The authentication and key exchange processing section 36 executes an authentication and key exchange process for the device at the other and of the network connection in order to transmit or receive content items in a network connection status. When content items that are an object of copyright protection are exchanged between digital information equipment, the digital information equipment are required to authenticate each other (AKE) in order to make sure that they are proper digital information equipment adapted to protect copyrights and licensed for copying content items by a specific licensing authority. As the mutual authentication (AKE) is completed successfully, the authentication and key exchange process section 36 exchanges the keys with the device at the other end of the network connection and shares the secret key that is generated as a result of the key exchange with the application at the other end for the purpose of encrypting and decrypting content items. The key selection process section 37 selects the secret key shared by the device at the other end of the network connection and the encryption process section 38 selectively encrypts and decrypts the content items by means of the secret key selected by the key selection process section 37.

FIG. 3 is a schematic exemplary illustration of the sequence of operation that is followed between the source device 10 and the sink device 20 for the purpose of reproducing the content items that are objects of copyright protection. In this operation, the sink device 20 firstly requests the source device 10 to transmit the content list. In response to the request from the sink device 20, the source device 10 transmits the content list to the sink device 20. Then, the sink device 20 selects the set of content items to be reproduced from the content list and requests the source device 10 to authenticate each other in order to exchange the keys necessary for reproducing the set of content items. Subsequently, the source device 10 and the sink device 20 authenticate each other and exchange the keys when the mutual authentication is successfully completed. As a result, the secret key is shared by the source device 10 and the sink device 20. Thereafter, as the sink device 20 requests the source device 10 to transmit the selected content items, the source device 10 encrypts the selected content items by means of the secret key and transmits them to the sink device 20. As the encrypted content items are received by the sink device 20, the sink device 20 decrypts and reproduces the encrypted content items by means of the secret key.

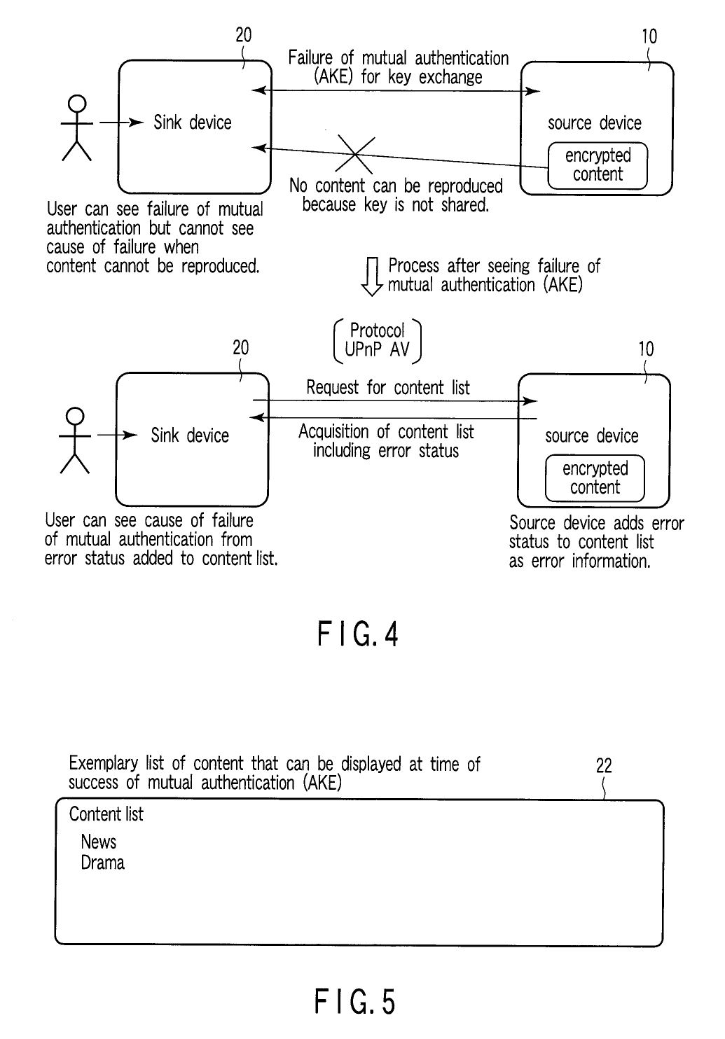

FIG. 4 is a schematic exemplary illustration of the operation of the source device 10 and that of the sink device 20 that are performed when they fail in mutual authentication (AKE). When the source device 10 and the sink device 20 fail in mutual authentication (AKE), the secret key is not shared by them. Therefore, the content items selected by the sink device 20 cannot be reproduced. At this time, while the user at the side of the sink device 20 can see that the mutual authentication failed as the source device 10 executes an error process, he or she cannot see the cause of the failure.

To dissolve this program, the authentication and key exchange process section 36 of this embodiment outputs the error status to the content list process section 35 when the mutual authentication ends in failure. Then, the content list process section 35 adds the error status at least as error information that makes the cause of the failure identifiable to the information of the content list.

As the user makes sure that the mutual authentication (AKE) ended in failure and requests the content list once again by way of the sink device 20, the source device 10 transmits the content list that includes the error status to the sink device 20. As the sink device 20 acquires the content list that includes the error status, it displays the content list. As a result, the user can see the cause of the failure in the mutual authentication from the error status.

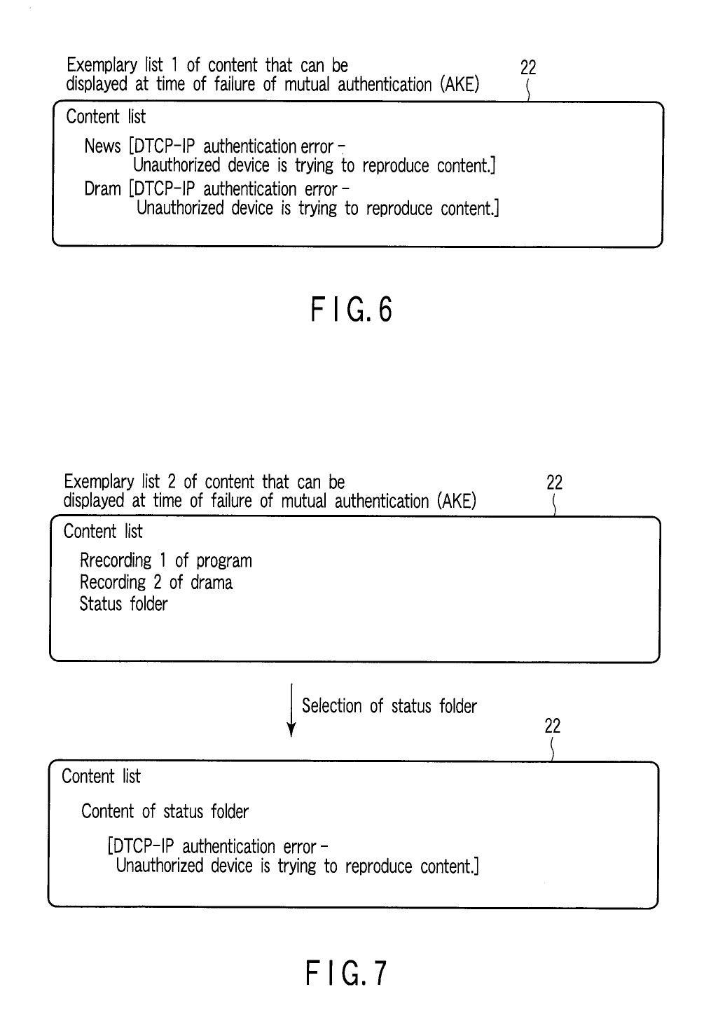

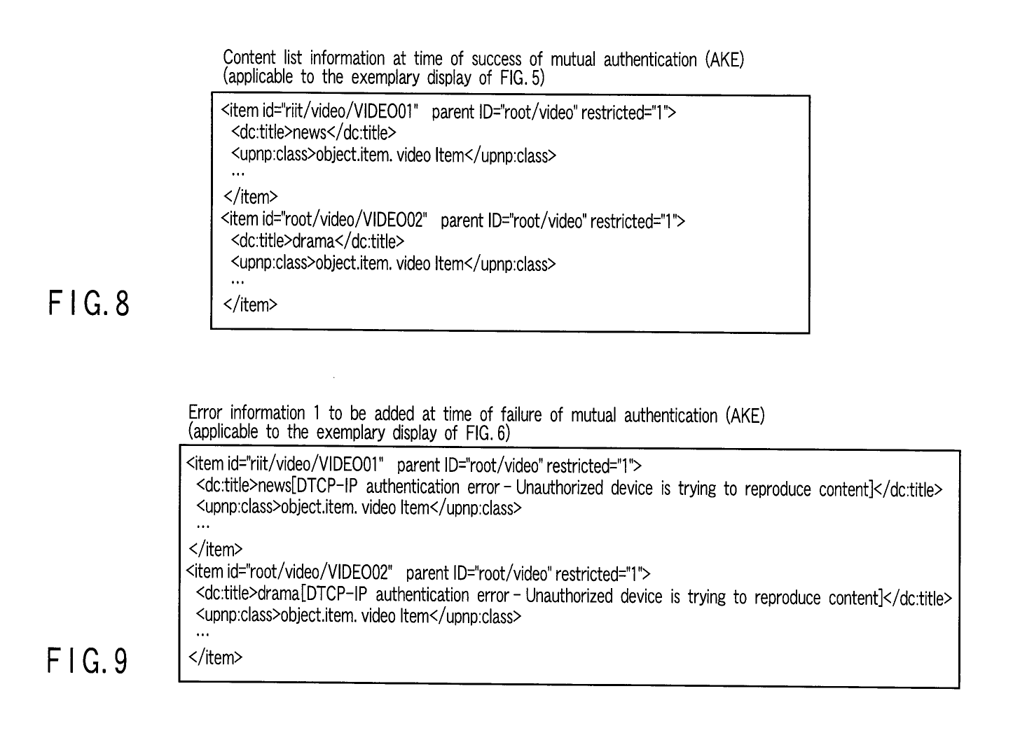

FIG. 5 is a schematic exemplary list of content items that can be displayed when the source device 10 and the sink device 20 succeed in mutual authentication (AKE). As seen from the displayed list, no error status is shown there. On the other hand, FIG. 6 is a schematic exemplary list of content items that can be displayed when the source device 10 and the sink device 20 fail in mutual authentication (AKE). As seen from the displayed list, the user can identify the cause of the failure in the mutual authentication because the error status, or the error information, of [DTCP-IP authentication error—An unauthorized device is trying to reproduce the content items] is displayed.

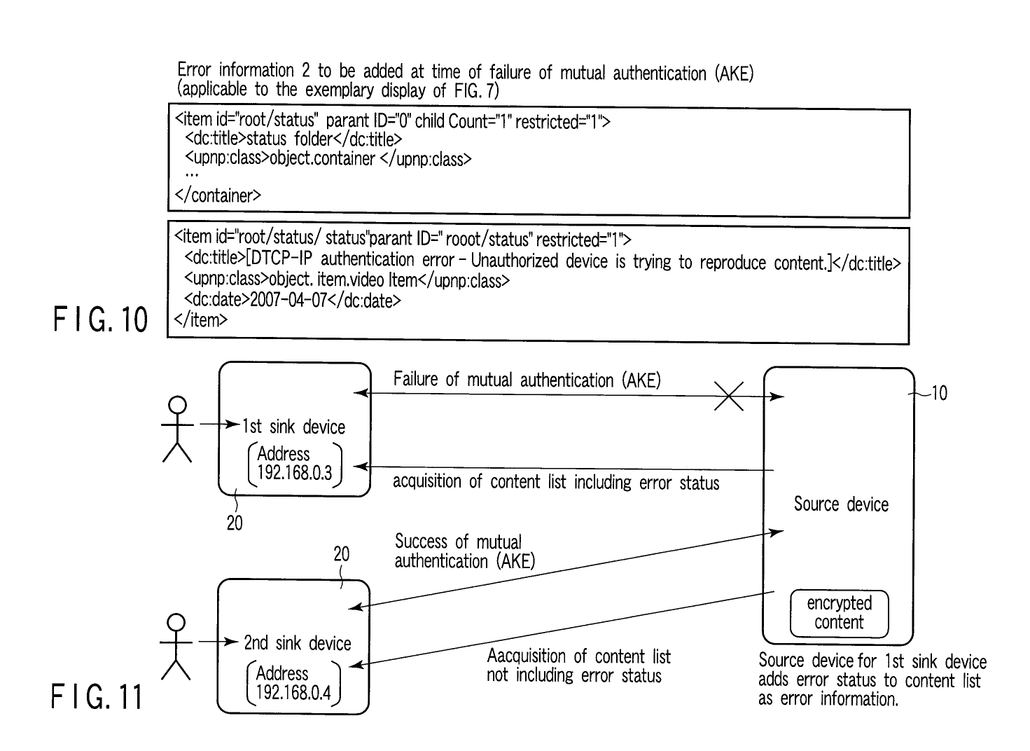

While the error status is added to each title of the content list shown in FIG. 6, the content list that is displayed when the mutual authentication (AKE) ends in failure may be modified so as to appear like the one illustrated in FIG. 7 when the content list can be handled by means of the directory (folder) structure. With this instance, the error status is output to the content list process section 35 when the authentication and key exchange process section 36 fails in the mutual authentication. The content list process section 35 prepares a folder titled as, for example, status folder and contains error information that makes at least the cause of the failure identifiable in the status folder. Then, it adds the information on the title of the status folder to the content list. As a result, a content list that includes an item of status folder is displayed as shown in FIG. 7. As the user selects the status folder, the error status, or the error information, of [DTCP-IP authentication error—an unauthorized device is trying to reproduce the content items] is added to the information of the content list and displayed on the sink device 20 as the content items of the status folder.

FIG. 8 is a schematic exemplary illustration of content list information applicable to the exemplary display of FIG. 5 when the source device 10 and the sink device 20 succeed in mutual authentication (AKE). FIG. 9 is a schematic exemplary illustration of error information to be added to content list information in order to obtain the exemplary display of FIG. 6 when the source device 10 and the sink device 20 fail in mutual authentication (AKE). FIG. 10 is a schematic exemplary illustration of error information to be added to content list information in order to obtain the exemplary display of FIG. 7 when the source device 10 and the sink device 20 fail in mutual authentication (AKE).

With this embodiment, when the sink device 20 requests the source device 10 to transmit the content list in response to the failure of the mutual authentication (AKE), error information that makes the cause of the failure identifiable is added to the content list to be transmitted at the source device 10 and the content list is transmitted to the sink device 10. Thus, the user can identify the cause of the failure of the mutual authentication with ease. Additionally, since the error information is transmitted to the sink device 20 by way of the connection management section for content lists 32 and the content list process section 35 that are existing resources for providing content lists, practically no additional cost is required to make the causes of failures identifiable.

Now, a home network system that can be used for the second embodiment of the present invention will be described below by referring to FIG. 11. The home network system illustrated in FIG. 11 includes the first and second sink devices 20 that are digital information equipment. Each of the sink devices 20 and the source device 10 have respective configurations that are the same as their counterparts of the first embodiment, the components thereof are denoted respectively by the same reference symbols and will not be described any further. Only the difference between the first embodiment and the second embodiment will be described below.

For example, the first sink device 20 is identified by address “192.168.0.3”, whereas the second sink device 20 is identified by address “192.168.0.4”. The source device 10 operates for each of the first and second sink devices 20 in a manner same as the one described above for the first embodiment. Note, however, that the source device 10 outputs the error status to the content list process section 35 when it fails in mutual authentication with either of the first and second sink devices 20. The content list process section 35 manages error statuses of each of the first and second sink devices 20 in such a way that it adds the error status to the content list information requested from the sink device 20 that fails in mutual authentication at least as error information that makes the cause of the failure identifiable.

Therefore, when the mutual authentication ends in failure between the first sink device 20 and the source device 10 but not between the second sink device 20 and the source device 10 as illustrated in FIG. 11, the first sink device acquires the content list that contains the error status, while the second sink device acquires the content list that does not contain the error status. The above description also applies to an arrangement where more than two sink devices 20 are connected to the source device 10 by network connection.

Thus, with this embodiment, when either of the first and second sink devices 20 that fails in mutual authentication (AKE) requests the content list, the source device 10 adds error information that makes the cause of the failure identifiable to the content list information and transmits it to the corresponding sink device 20. Therefore, the use can identify the cause of the failure in the mutual authentication with ease. When, on the other hand, the other sink device 20 that succeeds in mutual authentication (AKE) requests the content list, the source device 10 simply transmits the content list information to be transmitted to the sink device 20. Thus, the content list that does not contain any error information is displayed on the sink device 20. Additionally, since the error information is transmitted to the sink device 20 by way of the connection management section for content lists 32 and the content list process section 35 that are existing resources for providing content lists, practically no additional cost is required to make the causes of failures identifiable.

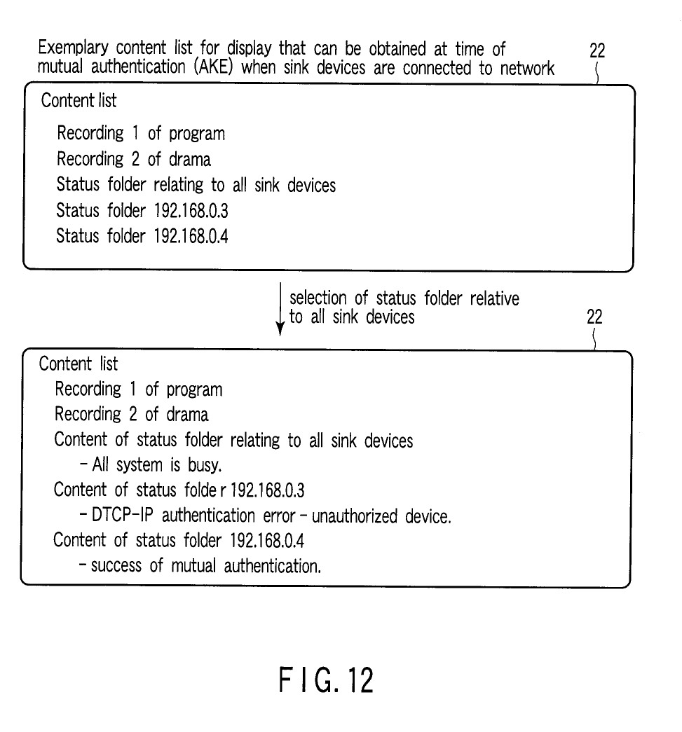

FIG. 12 is a schematic exemplary illustration of a modified format for displaying a content list that can be obtained as a result of mutual authentication (AKE) of FIG. 11. When the content list can be handled by means of the directory (folder) structure, the error status where the authentication and key exchange process section 36 fails in the mutual authentication is output to the content list process section 35 of each of the first and second sink devices 20. The content list process section 35 prepares folders titled respectively as, for example, 192.968.0.3 and 192.168.0.4 contains a notification of the success in the mutual authentication and error information that makes at least the cause of the failure identifiable in the status folder 192.968.0.3 and the status folder 192.168.04 respectively. Then, it adds the information on “the status folder relating to all the sink devices”and the titles of the status folders to the content list. As a result, a content list containing items of the status folder relating to all the sink devices, an item of the status folder 192.968.0.3 and an item of the status folder 192.168.0.4 are displayed as shown in FIG. 12. As the user selects the status folder relating to all the sink devices, the status of the entire system such as “—The entire system is busy—”, the status of the first sink device 20 such as “—DTCP-IP authentication error—An unauthorized device is trying to reproduce the content items—” and the status of the second sink device 20 such as “—Succeeded in mutual authentication—” are added to the content list and displayed on both the first and second sink devices 20.

With this embodiment, when a sink device requests the content list as a result of a failure in the mutual authentication, error information that makes the cause of the failure identifiable is added to the content list information to be transmitted. Therefore, the user can identify the cause of the failure that takes place in any mutual authentication with ease. Additionally, since error information is transmitted to the sink device by means of the existing resources adapted to transmit content lists, practically no additional cost is required to make the causes of failures identifiable.

The above-described embodiments can be modified in various different ways.

While the copyright protection process circuit of the sink device 20 has a configuration substantially equivalent to that of the copyright protection process circuit PR of the source device 10, encrypting processes that are not necessary at the side of the sink device 20 may be omitted if the content items that are objects of copyright protection are neither held in a memory arranged in the television set nor recorded on a DVD by means of a DVD recorder.

A copyright protection process circuit that is realized by means of software in the above description may alternatively be realized by means of hardware and arranged in each of the source device 10 and the sink device 20.

While certain embodiments of the invention have been described, these embodiments have been presented by way of example only and not intended to limit the scope of the invention. Indeed, the novel method and system described herein may be embodied in a variety of other forms; furthermore, various omissions, substitutions and changes in the form of the method and system described herein may be made without departing from the spirit of the invention. The accompanying claims and their equivalents are intended to cover such forms or modifications as would fall within the scope and spirit of the invention.

What is claimed is:

1. A copyright protection processing apparatus serving as source device capable of transmitting content items that are objects of copyright protection, the apparatus comprising:
a network interface which is connected to a sink device for receiving the content items;
a content list process section which transmits a list of content items transmittable to the sink device via the network interface in response to a request from the sink device; and
a protection process section which executes mutual authentication for exchanging keys via the network interface and performs a protection process of encrypting the content items by the secret key shared as a result of successful mutual authentication and transmitting the encrypted content items to the sink device; the content list process section being configured to add an item of error information to the content list to be transmitted to the sink device, upon failure in the mutual authentication executed by the protection process section.

2. The apparatus according to claim 1, wherein the content list process section is configured to provide a status folder for holding the error information and add an item of the error information to the content list as the content of the status folder.

3. The apparatus according to claim 1, wherein the protection process section is configured to execute mutual authentication for exchanging keys with another sink device in a status where a network connection is established with the other sink device via the network interface in addition to the sink device; and the content list process section is configured to add the item of error information only to the content list to be transmitted to the sink device that fails in the mutual authentication.

4. The apparatus according to claim 3, wherein the content list process section is configured to provide a status folder for holding the error information for each of the sink devices and add an item of the error information to the content list as the content of the status folder.

5. The apparatus according to claim 1, wherein the content list is transmitted by UPnP AV.

6. A copyright protection method comprising:
transmitting a content list transmittable to a sink device in response to a request from the sink device;
executing mutual authentication for a key exchange requested by the sink device in a status where a network connection is established with the sink device which utilizes content items that are objects of protection;
performing a protection process of encrypting the content items by the secret key shared as a result of successful mutual authentication and transmitting the encrypted content items to the sink device; and
adding an item of error information to the content list to be transmitted to the sink device upon failure in the mutual authentication.

7. The method according to claim 6, wherein a status folder is provided for holding the error information, and an item of error information is added to the content list as the content of the status folder.

8. The method according to claim 6, wherein in a status where a network connection is established with another sink device via the network interface in addition to the sink device, mutual authentication for exchanging keys is executed in response to a request from the other sink device, and the item of error information is added only to the content list to be transmitted to the sink device that fails in the mutual authentication.

9. The method according to claim 8, wherein a status folder for holding the error information is provided for each of the sink devices, and an item of the error information is added to the content list as the content of the status folder.

10. The method according to claim 6, wherein the content list is transmitted by UPnP AV.
